(19) United States
(12) Patent Application Publication
(10) Pub. No.: US 2026/0097777 A1
(43) Pub. Date: Apr. 9, 2026

(54) VEHICLE DRIVING ASSISTANCE APPARATUS, AN OPERATING METHOD THEREOF, AND A VEHICLE INCLUDING SAME

(71) Applicants: HYUNDAI MOTOR COMPANY, Seoul (KR); KIA CORPORATION, Seoul (KR)

(72) Inventors: Sun Young Park, Hwaseong-si (KR); Ji Hoon Kang, Hwaseong-si (KR)

(73) Assignees: HYUNDAI MOTOR COMPANY, Seoul (KR); KIA CORPORATION, Seoul (KR)

(21) Appl. No.: 19/200,291

(22) Filed: May 6, 2025

(30) Foreign Application Priority Data
Oct. 8, 2024 (KR) 10-2024-0136832

(51) Int. Cl. B60W 50/08; B60W 30/14; B60W 30/18; B60W 40/09

(52) U.S. Cl. CPC B60W 50/085; B60W 30/14; B60W 30/18127; B60W 40/09; B60W 2510/101; B60W 2510/18; B60W 2520/10; B60W 2540/10; B60W 2540/12; B60W 2540/16; B60W 2554/80

(57) ABSTRACT

A vehicle driving assistance apparatus is implemented to determine priorities for vehicle driving assistance functions and perform vehicle driving assistance functions according to the determined priorities. The vehicle driving assistance apparatus includes a communication device configured to receive operation information required to perform vehicle driving assistance functions, and a controller configured to determine a priority for two or more functions that are not able to be performed simultaneously based on driving tendencies of a driver, among the vehicle driving assistance functions, wherein the vehicle driving tendencies of the driver are analyzed based on the operation information and to control driving of a vehicle by controlling an actuator based on the determined priority. The vehicle driving assistance functions include two or more functions that cannot be performed simultaneously.

### CROSS-REFERENCE TO THE RELATED APPLICATION

The present application claims the benefit of and priority to Korean Patent Application No. 10-2024-0136832, filed on Oct. 8, 2024, the disclosure of which is incorporated herein by reference in its entirety.

### TECHNICAL FIELD

The present disclosure relates to an apparatus for assisting vehicle driving, and more particularly, to a vehicle driving assistance apparatus implemented to determine priorities for various types of vehicle driving assistance functions depending on driver's driving tendencies and perform vehicle driving assistance functions according to the determined priorities, an operating method thereof, and a vehicle including the same.

### BACKGROUND

Various types of vehicle driving assistance functions for assisting drivers in driving vehicles and improving driving safety and convenience are installed in vehicles.

For example, vehicle driving assistance functions such as Smart Cruise Control (SCC), Navigation-based Smart Cruise Control (NSCC), Smart Regenerative Braking System (SRS), inertial driving notification function, Forward Collision Avoidance (FCA), Autonomous Emergency Brake (AEB), and Driver Attention Warning (DAW) may be installed in vehicles.

Some of various types of vehicle driving assistance functions installed in a vehicle cannot be performed simultaneously and are performed according to an initial priority.

Since vehicle driving assistance functions performed according to an initial priority assist vehicle driving regardless of driver's driving tendencies, the efficiency and usability of the vehicle driving assistance functions are low.

The statements in this Background section merely provide background information related to the present disclosure and may not constitute prior art.

The matters described as the background technology above are only for the purpose of enhancing understanding of the background of the present disclosure and should not be accepted as acknowledging that they correspond to prior art already known to those having ordinary skill in the art.

### SUMMARY

A method of improving the efficiency and usability of vehicle driving assistance functions by causing the vehicle driving assistance functions to be performed in consideration of driver's driving tendencies is required.

Therefore, the present disclosure has been made in view of the above problems, and it is an object of the present disclosure to provide a vehicle driving assistance apparatus implemented to perform vehicle driving assistance functions in consideration of driver's driving tendencies, an operating method thereof, and a vehicle including the same.

It is another object of the present disclosure to provide a vehicle driving assistance apparatus implemented to determine priorities for vehicle driving assistance functions that cannot be performed simultaneously among vehicle driving assistance functions and to perform vehicle driving assistance functions according to the determined priorities, an operating method thereof, and a vehicle including the same.

It is a further object of the present disclosure to provide a vehicle driving assistance apparatus implemented to obtain information necessary for operations required to determine priorities for vehicle driving assistance functions in order to reflect driver's driving tendencies and to determine priorities for vehicle driving assistance functions based on the obtained information, operating method thereof, and a vehicle including the same.

The technical objects to be achieved in the present disclosure are not limited to the technical objects mentioned above, and other technical objects not mentioned herein should be clearly understood by those having ordinary skill in the art to which the present disclosure belongs from the description below.

In accordance with an aspect of the present disclosure, the above and other objects can be accomplished by the provision of a vehicle driving assistance apparatus. The vehicle driving assistance apparatus includes a communication device configured to receive operation information required to perform vehicle driving assistance functions, and a controller configured to determine a priority for two or more functions that are not able to be performed simultaneously based on (e.g., depending on) driving tendencies of a driver, among the vehicle driving assistance functions, wherein the vehicle driving tendencies of the driver are analyzed based on the operation information and to control driving of a vehicle by controlling an actuator based on the determined priority.

According to an embodiment of the present disclosure, the vehicle driving assistance functions may include a smart cruise control function, a smart regenerative braking function, and an inertial driving function.

According to an embodiment of the present disclosure, when a preset deceleration even occurs, the controller may preferentially perform one of the smart t cruise control function, the smart regenerative braking function, or the inertial driving function based on the determined priority.

According to an embodiment of the present disclosure, the controller may determine priorities for the vehicle driving assistance functions when all of the vehicle driving assistance functions are activated.

According to an embodiment of the present disclosure, the controller may count, based on the operation information, a number of paddle shift operations and a number of times of neutral driving, calculate an accelerator pedal score and a brake pedal score, and determine priorities for the vehicle driving assistance functions based on the number of paddle shift operations, the number of times of neutral driving operations, the accelerator pedal score, and the brake pedal score.

According to an embodiment of the present disclosure, the operation information may include an operation signal provided from a paddle shift and a neutral gear signal provided from a gear sensor. Further, the controller may count the number of paddle shift operations based on the operation signal and count the number of times of neutral driving based on the neutral gear signal.

According to an embodiment of the present disclosure, the controller may determine whether an operation execution condition is satisfied based on the operation information, and calculate the accelerator pedal score and the brake pedal score in response to the operation execution condition being satisfied.

According to an embodiment of the present disclosure, the controller may determine whether a deceleration event occurs within a preset distance based on the operation information, and determine that the operation execution condition is satisfied in response to a determination that the deceleration event occurs.

According to an embodiment of the present disclosure, the operation information may include information on a remaining distance to an obstacle or an obstacle section present in a driving section of the vehicle. Further, the controller may determine that the deceleration event occurs in response to the obstacle or the obstacle section being present within the preset distance.

According to an embodiment of the present disclosure, the operation information may include vehicle speed information provided by a speed sensor. Further, the controller may compare, in response to the operation execution condition being satisfied, the vehicle speed information with a preset critical speed and calculate an accelerator pedal score or a brake pedal score based on a comparison result.

According to an embodiment of the present disclosure, the controller may calculate the accelerator pedal score in response to a vehicle speed being less than the preset critical speed and calculate the brake pedal score in response to the vehicle speed being equal to or greater than the preset critical speed.

According to an embodiment of the present disclosure, the operation information may include accelerator pedal operation information provided from an accelerator pedal position sensor, brake pedal operation information provided from a brake pedal position sensor, and information on a remaining distance to an obstacle or obstacle section present in a driving section of the vehicle. Further, the controller may calculate the accelerator pedal score based on the accelerator pedal operation information and the remaining distance information (i.e., the information on the remaining distance), and calculate the brake pedal score based on the brake pedal operation information and the remaining distance information.

According to an embodiment of the present disclosure, the controller may calculate an acceleration index based on the accelerator pedal score and the number of times of neutral driving, calculate a braking index based on the brake pedal score, the number of times of neutral driving, and the number of paddle shift operations, and determine the priorities for the vehicle driving assistance functions based on the acceleration index and the braking index.

According to an embodiment of the present disclosure, the controller may compare the acceleration index with a preset first reference value, and determine a smart cruise controller function to be preferentially performed in response to the acceleration index being equal to or greater than the first preset reference value.

According to an embodiment of the present disclosure, the controller may compare the acceleration index with a preset first reference value, compare the braking index with a preset second reference value in response to the acceleration index being less than the preset first reference value, determine a smart regenerative braking function to be performed preferentially in response to the braking index being equal to or greater than the preset second reference value, and determine an inertial driving function to be performed preferentially in response to the braking index being less than the preset second reference value.

According to an embodiment of the present disclosure, the controller may determine the priorities for the vehicle driving assistance functions based on a driving pattern score corresponding to the sum of the accelerator pedal score and the braking pedal score.

According to an embodiment of the present disclosure, the controller may compare the driving pattern score with a first comparison value and a second comparison value set in advance, determine inertial driving to be performed preferentially in response to the driving pattern score being less than the first comparison value, determine a smart regenerative braking function to be performed preferentially in response to the driving pattern score being equal to or greater than the first comparison value and less than the second comparison value, and determine a smart cruise control function to be performed preferentially in response to the driving pattern score being equal to or greater than the second comparison value.

According to an embodiment of the present disclosure, the controller may compare the number of paddle shift operations or the number of times of neutral driving with a preset limit value based on (e.g., depending on) a vehicle driving assistance function determined based on the driving pattern score, and change a vehicle driving assistance function to be performed preferentially based on a comparison result.

In accordance with another aspect of the present disclosure, an operating method of a vehicle driving assistance apparatus includes receiving operation information required to perform vehicle driving assistance functions, determining a priority for two or more functions that are not able to be performed simultaneously based on (e.g., according to) driving tendencies of a driver, among the vehicle driving assistance functions, wherein the driving tendencies of the driver are analyzed based on the operation information, and controlling driving of a vehicle by controlling an actuator based on the determined priority, wherein the vehicle driving assistance functions include the two or more functions that are not able to be performed simultaneously.

In accordance with a further aspect of the present disclosure, a vehicle includes: a vehicle driving assistance apparatus configured to determine a priority for two or more functions that are not able to be performed simultaneously based on (e.g., according to) driving tendencies of a driver, among vehicle driving assistance functions, wherein the driving tendencies of the driver are analyzed based on received operation information and to control driving of the vehicle by controlling an actuator based on the determined priority; and an information acquisition device configured to acquire the operation information and to provide the operation information to the vehicle driving assistance apparatus.

### BRIEF DESCRIPTION OF THE DRAWINGS

FIG. 1 is a diagram showing a vehicle equipped with a vehicle driving assistance apparatus according to an embodiment of the present disclosure;

FIG. 2 is a diagram showing a configuration of an information acquisition device according to an embodiment of the present disclosure;

FIG. 3 is a diagram showing a configuration of an output interface according to an embodiment of the present disclosure;

FIG. 4 is a diagram showing a configuration of an actuator according to an embodiment of the present disclosure;

FIG. 5 is a diagram showing a configuration of the vehicle driving assistance apparatus according to an embodiment of the present disclosure;

FIG. 6 is a flow chart illustrating an operating method of a vehicle driving assistance apparatus according to an embodiment of the present disclosure;

FIG. 7 is a flow chart showing a specific example of a priority determination step S670 of FIG. 6; and

FIG. 8 is a flow chart showing another specific example of the priority determination step S670 of FIG. 6.

The drawings described herein are for illustration purposes only and are not intended to limit the scope of the present disclosure in any way.

### DETAILED DESCRIPTION

In the following description of embodiments disclosed in the present disclosure, a detailed description of known functions and configurations incorporated herein have been omitted when it may obscure the subject matter of the present disclosure. In addition, the accompanying drawings are provided only for ease of understanding of embodiments disclosed in the present disclosure, do not limit the technical spirit disclosed herein, and include all changes, equivalents and substitutes included in the spirit and scope of the present disclosure.

The terms “first” and/or “second” and the like are used to describe various components, but such components are not limited by these terms. The terms are used to discriminate one component from another component.

An element described in the singular form is intended to include a plurality of elements unless the context clearly indicates otherwise.

In the present disclosure, it should be further understood that the term “comprise,” “have,” or “include” specifies the presence of a stated feature, figure, step, operation, component, part or combination thereof, but does not preclude the presence or addition of one or more other features, figures, steps, operations, components, or combinations thereof.

The suffixes “module” and “unit” of elements used in the following description are used for convenience of description and thus can be used interchangeably and do not have any distinguishable meanings or functions.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

When a component, unit, module, processor, controller, device, element, apparatus, or the like of the present disclosure is described as having a purpose or performing an operation, function, or the like, the component, unit, module, processor, controller, device, element, apparatus, or the like should be considered herein as being “configured to” meet that purpose or to perform that operation or function. Each component, unit, module, processor, controller, device, element, apparatus, and the like may separately embody or be included with a processor and a memory, such as a non-transitory computer readable media, as part of the apparatus. The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments disclosed in the present disclosure are described in detail with reference to the attached drawings. However, identical or similar components have been assigned the same reference numeral, and redundant descriptions thereof have been omitted.

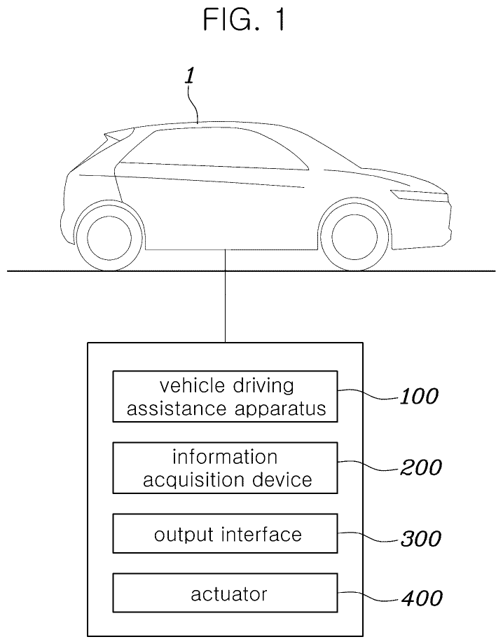

FIG. 1 is a diagram showing a vehicle 1 equipped with a vehicle driving assistance apparatus 100 according to an embodiment of the present disclosure.

Referring to FIG. 1, the vehicle 1 according to an embodiment of the present disclosure may include the vehicle driving assistance apparatus 100.

The vehicle 1 may include an information acquisition device 200 that provides information necessary for operation of the vehicle driving assistance apparatus 100 (hereinafter, “operation information”), an output interface 300 that outputs information provided from the vehicle driving assistance apparatus 100, and an actuator 400 that operates according to control of the vehicle driving assistance apparatus 100.

The vehicle 1 may be a vehicle equipped with a motor as a power source. For example, the vehicle 1 may be an electric vehicle EV, a hybrid electric vehicle HEV, a plug-in hybrid electric vehicle PHEV, a fuel cell electric vehicle (FCEV), or the like.

According to an embodiment, the vehicle driving assistance apparatus 100 may perform a vehicle driving assistance function by operating according to a vehicle driving assistance algorithm based on the operation information provided from the information acquisition device 200.

The vehicle driving assistance apparatus 100 may provide information generated or acquired in the process of performing a vehicle driving assistance function to the output interface 300. The vehicle driving assistance apparatus 100 may control the actuator 400 in the process of performing a vehicle driving assistance function.

A specific description of the configuration and operation of the vehicle driving assistance apparatus 100 are described below.

The information acquisition device 200 may acquire information (operation information) necessary for the vehicle driving assistance apparatus 100 to operate and provide the acquired information to the vehicle driving assistance apparatus 100.

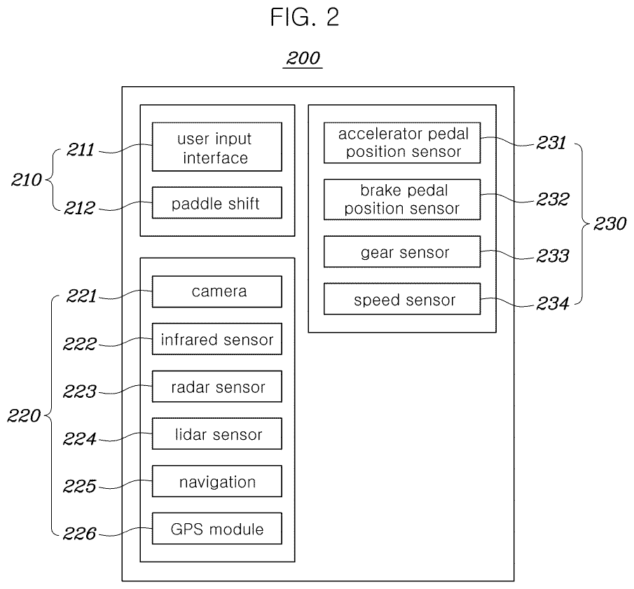

FIG. 2 is a diagram showing a configuration of the information acquisition device 200 according to an embodiment of the present disclosure.

Referring to FIG. 2, the information acquisition device 200 may include a first information acquisition device 210, a second information acquisition device 220, and a third information acquisition device 230.

The first information acquisition device 210 may be implemented to acquire information input by a user (hereinafter, user input information). The first information acquisition device 210 may provide the acquired user input information to the vehicle driving assistance apparatus 100.

For example, the first information acquisition device 210 may include a user input interface 211 and a paddle shift 212. For example, the first information acquisition 210 may be implemented to receive information on whether a vehicle driving assistance function is activated, information on a performance level of a vehicle driving assistance function, and information on a regenerative braking level. For example, the user input interface 211 may be a user setting manual (USM).

For example, the user input interface 211 may include a plurality of setting means for receiving user instructions for activating each of the vehicle driving assistance functions. For example, the user input interface 211 may include a first setting means for receiving an instruction for activating a smart cruise control (SCC) function, a second setting means for receiving an instruction for activating a smart regenerative braking system (SRS) function, and a third setting means for receiving an instruction for activating an inertial driving function.

As another example, the user input interface 211 may include one setting means for receiving a user instruction to activate all vehicle driving assistance functions.

The second information acquisition device 220 may be implemented to acquire information related to an environment in which the vehicle 1 travels (hereinafter, driving environment information). The second information acquisition device 220 may provide the acquired driving environment information to the vehicle driving assistance apparatus 100.

For example, the second information acquisition device 220 may acquire driving path information, road information on a driving path, vehicle surrounding information, vehicle location information, and the like. For example, the second information acquisition device 220 may include a camera (221), an infrared sensor 222, a radar sensor 223, a lidar sensor 224, a navigation system 225, and a global position system (GPS) module 226.

For example, driving path information, road information, vehicle surrounding information, and vehicle location information may be acquired by one device constituting the second information acquisition device 220, or may be acquired by combining information acquired by multiple devices.

The third information acquisition device 230 may be implemented to acquire status information (hereinafter, vehicle status information) of the vehicle 1. The third information acquisition device 230 may provide the acquired vehicle status information to the vehicle driving assistance apparatus 100.

For example, the third information acquisition device 230 may include a sensor (accelerator pedal position sensor (APS)) 231 for detecting operation of an accelerator pedal, a sensor (brake pedal position sensor (BPS)) 232 for detecting operation of a brake pedal, a sensor (gear sensor) 233 for detecting a gear stage, a speed sensor 234 for detecting the speed (vehicle speed) of the vehicle 1, and the like.

The output interface 300 may output information provided from the vehicle driving assistance apparatus 100 according to preset settings.

For example, the output interface 300 may receive priority information on a vehicle driving assistance function from the vehicle driving assistance apparatus 100 and output the received priority information.

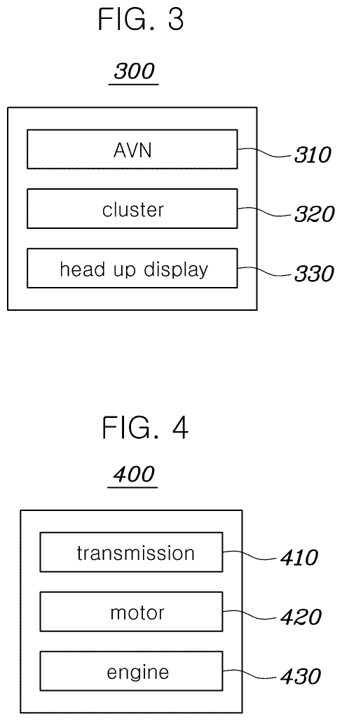

FIG. 3 is a diagram showing a configuration of the output interface 300 according to an embodiment of the present disclosure.

As shown in FIG. 3, the output interface 300 may include any one of an audio video navigation (AVN) device 310, a cluster 320, and a head up display 330, and the type of the output interface 300 is not limited thereto.

The actuator 400 operates according to control of the vehicle driving assistance apparatus 100 to achieve a function to be performed by the vehicle driving assistance apparatus 100.

FIG. 4 is a diagram showing a configuration of the actuator 400 according to an embodiment of the present disclosure.

As shown in FIG. 4, the actuator 400 may include a transmission 410, a motor 420, an engine 430, and the like, and the type of the actuator 400 is not limited thereto.

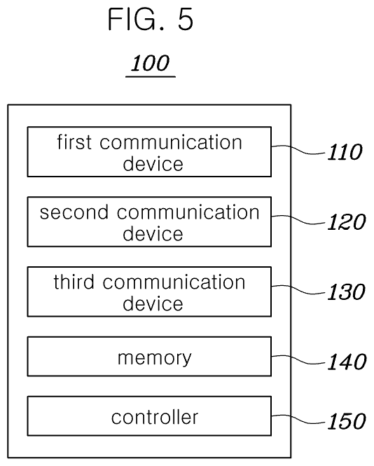

FIG. 5 is a diagram showing a configuration of the vehicle driving assistance apparatus 100 according to an embodiment of the present disclosure.

The vehicle driving assistance apparatus 100 may be implemented to perform a vehicle driving assistance function in consideration of driver's driving tendencies.

According to an embodiment, the vehicle driving assistance apparatus 100 may be implemented to determine priorities for vehicle driving assistance functions that cannot be performed simultaneously among vehicle driving assistance functions and to perform vehicle assistance driving assistance functions according to the determined priorities.

The vehicle 1 may be equipped with two or more vehicle driving assistance functions that cannot be performed simultaneously.

For example, vehicle driving assistance functions that cannot be performed simultaneously may include, but are not limited to, a smart cruise control (SCC) function, a smart regenerative braking system (SRS) function, an inertial driving function, and the like.

Referring to FIG. 5, the vehicle driving assistance apparatus 100 may include a first communication device 110, a second communication device 120, a third communication device 130, a memory 140, and a controller 150, and the configuration of the vehicle driving assistance apparatus 100 is not limited thereto.

For example, the vehicle driving assistance apparatus 100 may be implemented as a hybrid control unit (HCU), a vehicle control unit (VCU), or an electric control unit (ECU).

The first communication device 110 may communicate with the information acquisition device 200, receive information provided from the information acquisition device 200, and transmit the received information to the controller 150.

For example, the first communication device 110 may be composed of one or more communication modules. The one or more communication modules may communicate with the information acquisition device 200 based on a preset communication protocol. For example, the first communication device 110 may communicate with the information acquisition device 200 based on a communication protocol such as Local Interconnect Network (LIN), Controller Area Network (CAN), FlexRay, Ethernet, and the like.

The second communication device 120 may communicate with the output interface 300 and provide information provided from the controller 150 to the output interface 300.

For example, the second communication device 120 may be composed of one or more communication modules. The one or more communication modules may communicate with the information acquisition device 200 based on a preset communication protocol. For example, the second communication device 120 may communicate with the output interface 300 based on a communication protocol such as Local Interconnect Network (LIN), Controller Area Network (CAN), FlexRay, Ethernet, and the like.

The third communication device 130 may communicate with the actuator 400 and output a control signal to the actuator 400.

For example, the third communication device 130 may be composed of one or more communication modules. The one or more communication modules may communicate with the actuator 400 based on a preset communication protocol. For example, the third communication device 130 may communicate with the actuator 400 based on a communication protocol such as Local Interconnect Network (LIN), Controller Area Network (CAN), FlexRay, Ethernet, and the like.

The memory 140 may store algorithms, data, and the like. for performing operations of the controller 150.

The memory 140 may include a volatile memory and/or a non-volatile memory. The volatile memory may include dynamic random access memory (DRAM), static RAM (SRAM), synchronous DRAM (SDRAM), phase-change RAM (PRAM), magnetic RAM (MRAM), resistive RAM (RRAM), and ferroelectric RAM (FeRAM). The non-volatile memory may include read only memory (ROM), programmable ROM (PROM), electrically programmable ROM (EPROM), electrically erasable programmable ROM (EEPROM), and flash memory.

The controller 150 may perform vehicle driving assistance functions according to an algorithm stored in the memory 140. The controller 150 may perform vehicle driving assistance functions using information provided from the information acquisition device 200.

The controller 150 may be implemented as at least one processor. The at least one processor may be a hardware data processing device including a circuit having a physical structure for executing desired operations. For example, the desired operations may include code or instructions included in a program.

For example, the hardware data processing device may include a microprocessor, a central processing unit, a processor core, a multi-core processor, a multiprocessor, an application-specific integrated circuit (ASIC), and a field programmable gate array (FPGA).

According to an embodiment, the controller 150 may determine whether a vehicle driving assistance function is activated based on operation information provided from the information acquisition device 200.

For example, the controller 150 may determine whether a vehicle driving assistance function is activated based on user input information provided from the user input interface 211 of the first information acquisition device 210. For example, the controller 150 may determine whether the Smart Cruise Control (SCC) function, the Smart Regenerative Braking System (SRS) function, and the inertial driving function have been activated based on information on whether vehicle driving assistance function activation included in the user input information.

According to an embodiment, upon determining that all preset vehicle driving assistance functions have been activated, the controller 150 may determine whether a deceleration event occurs within a preset distance (e.g., 1 km) based on operation information provided from the information acquisition device 200.

For example, the controller 150 may determine whether a deceleration event occurs based on driving environment information provided from the second information acquisition device 220.

For example, the controller 150 may determine whether a deceleration event occurs within a preset distance based on presence or absence of a preceding vehicle, presence or absence of a toll gate, presence or absence of a speed bump, presence or absence of a speed camera, and presence or absence of an intersection.

In this manner, the controller 150 may determine that a deceleration event occurs upon determining that there is a preset obstacle or obstacle section within the preset distance.

According to an embodiment, upon determining that all preset vehicle driving assistance functions have been activated, the controller 150 may count the number of paddle shift operations and the number of times of neutral driving based on operation information provided from the information acquisition device 200.

For example, the controller 150 may count the number of paddle shift operations based on an operation signal provided from the paddle shift 212 of the first information acquisition device 210. For example, the controller 150 may count the number of times of neutral driving based on a neutral gear signal provided from the gear sensor 233 of the third information acquisition device 230.

The operation signal may be output from the paddle shift 212 when a user operation for regenerative braking of the vehicle 1 is performed, and the neutral gear signal may be output from the gear sensor 233 when the vehicle 1 is in neutral.

According to an embodiment, upon determining that a deceleration event occurs within a preset distance, the controller 150 may compare the current vehicle speed with a preset critical speed based on the operation information provided from the information acquisition device 200 and determine whether the current vehicle speed is less than the critical speed.

For example, the controller 150 may compare the current vehicle speed with the critical speed based on speed information provided from the speed sensor 234 of the third information acquisition device 230.

The controller 150 may calculate a score for the accelerator pedal or a score for the brake pedal based on the result of comparison between the current vehicle speed and the critical speed, that is, the result of determining whether the current vehicle speed is below the critical speed.

For example, the controller 150 may calculate a score for the accelerator pedal if the current vehicle speed is below the critical speed and may calculate a score for the brake pedal if the current vehicle speed is equal to or greater than the critical speed.

The controller 150 may calculate a score for the accelerator pedal based on driving environment information provided from the second information acquisition device 220 and accelerator pedal operation information provided from the accelerator pedal position sensor 231 of the third information acquisition device 230.

For example, the controller 150 may calculate a score for the accelerator pedal based on at least two pieces of information among an accelerator pedal operation count, an accelerator pedal stroke, an accelerator pedal operation time, and the remaining distance from the current position of the vehicle 1 to a point where the deceleration event occurs.

For example, the controller 150 may calculate an accelerator pedal score A according to the following mathematical expression 1. However, the method of calculating the accelerator pedal score A is not limited thereto.

$$A = {a}_{1} * ( operation count / remaining distance ) + {a}_{2} * ( stroke * operation time / remaining distance ) \qquad [ Mathematical expression 1 ]$$

In Mathematical expression 1, a₁ and a₂ are weights set through experiments to be applied when calculating the accelerator pedal score A.

The controller 150 may calculate a score for the brake pedal based on the driving environment information provided from the second information acquisition device 220 and the brake pedal operation information provided from the brake pedal position sensor 232 of the third information acquisition device 230.

For example, the controller 150 may calculate a score for the brake pedal based on at least two pieces of information among a brake pedal operation count, a brake pedal strokes, a brake pedal operation time, and the remaining distance from the current position of the vehicle to a point where the deceleration event occurs.

For example, the controller 150 may calculate a brake pedal score B according to the following mathematical expression 2. However, the method of calculating the brake pedal score B is not limited thereto.

$$B = {b}_{1} * ( operation count / remaining distance ) + {b}_{2} * ( stroke * operation time / remaining distance ) \qquad [ Mathematical expression 2 ]$$

In Mathematical expression 2, b₁ and b₂ are weights set through experiments to be applied when calculating the brake pedal score.

According to an embodiment, the controller 150 may determine a driving pattern based on the accelerator pedal score A, the brake pedal score B, a paddle shift operation count C, and a neutral driving count D, and determine a priority for a vehicle driving assistance function based on the driving pattern.

According to an embodiment, the driving pattern may be represented as a score or an index as described below.

The controller 150 may calculate an acceleration index E and a braking index F based on at least two pieces of information among the accelerator pedal score A, the brake pedal score B, a paddle shift operation count C, and the neutral driving count D before determining a priority for a vehicle driving assistance function. The acceleration index E and the braking index F may be referred to as a driving pattern score.

In addition, the controller 150 may determine a priority for a vehicle driving assistance function based on the acceleration index E and the braking index F.

In other words, the controller 150 may calculate the acceleration index E and the braking index F based on at least two pieces of information among the accelerator pedal score A, the brake pedal score B, the paddle shift operation count C, and the neutral driving count D, and may determine a priority for a vehicle driving assistance function based on the calculated acceleration index E and braking index F.

For example, the controller 150 may calculate the acceleration index E based on the accelerator pedal score A and the neutral driving count D.

For example, the controller 150 may calculate the acceleration index E according to the following mathematical expression 3. However, the method of calculating the acceleration index E is not limited thereto.

$$[ Mathematical expression 3 ]$$

$$E = accelerator pedal score A - {e}_{1} * neutral driving count D$$

In Mathematical expression 3, e₁ is a weight set through an experiment to be applied when calculating the acceleration index E.

For example, the controller 150 may calculate the braking index F based on the braking pedal score B, the paddle shift operation count C, and the neutral driving count D.

For example, the controller 150 may calculate the braking index F according to the following mathematical expression 4. However, the method of calculating the braking index F is not limited thereto.

$$F = brake pedal score B - {f}_{1} * neutral driving count D + {f}_{2} * paddle shift operation count C \qquad [ Mathematical expression 4 ]$$

In Mathematical expression 4, f₁ and f₂ are weights set through experiments to be applied when calculating the braking index F.

According to an embodiment, in the case of a driving pattern having a characteristic in which coasting driving is preferred for a deceleration event, the controller 150 may determine a priority of an inertial driving function to be higher than priorities of other vehicle driving assistance functions.

According to an embodiment, in the case of a driving pattern having characteristics in which frequent use of the brake pedal and driving below a critical speed are preferred for a deceleration event, the controller 150 may determine a priority of the smart regenerative braking function to be higher than priorities of other vehicle driving assistance functions.

According to an embodiment, in the case of a driving pattern having characteristics in which the accelerator pedal and the brake pedal are not frequently used for a deceleration event, the controller 150 may determine a priority of the smart cruise control function to be higher than priorities of other vehicle driving assistance functions.

According to an embodiment, in the case of a driving pattern having characteristics in which the paddle shift is frequently used, the controller 150 may determine a priority of the smart regenerative braking function to be higher than priorities of other vehicle driving assistance functions.

According to an embodiment, in the case of a driving pattern having characteristics in which neutral driving is frequently performed, the controller 150 may determine a priority of the inertial driving function to be higher than priorities of other vehicle driving assistance functions.

Table 1 summarizes priorities of vehicle driving assistance functions determined according to an embodiment of the present disclosure.

TABLE 1

| | F < k | F ≥ k |
|---|---|---|
| E < l | Inertial driving | Smart regenerative |
| | | braking |

| | |
|---|---|
| E ≥ l | Smart cruise control |

As shown in Table 1, the controller 150 may determine that the inertial driving function is performed preferentially if the acceleration index E is less than a preset first reference value (or acceleration index reference value) l and the braking index F is less than a preset second reference value (or braking index reference value) k.

The controller 150 may determine that the smart regenerative braking function is preferentially performed if the acceleration index E is less than the first reference value l and the braking index F is equal to or greater than the second reference value k.

The controller 150 may determine that the smart cruise control function is preferentially performed regardless of the braking index F if the acceleration index E is equal to or greater than the first reference value l.

The first reference value of l and the second reference value k may be set through experiments with various conditions in order to be used to determine which vehicle driving assistance function is useful depending on the driving pattern.

In this manner, according to priority determination according to an embodiment of the present disclosure, the smart cruise control function may be preferentially performed when the acceleration index E is high, the smart regenerative braking function may be preferentially performed when only the braking index F is high, and the inertial driving function may be preferentially performed when both the acceleration index E and the braking index F are low.

According to an embodiment, since the priority of the inertial driving function needs to be set higher than the priorities of other vehicle driving assistance functions when both the acceleration index E and the braking index F are low, the neutral driving count D, which is a condition for increasing the priority of inertial driving, may be applied as a subtraction (−) parameter to the formulas for calculating the acceleration index E and the braking index F (Mathematical expressions 3 and 4).

According to an embodiment, since the priority of the smart regenerative braking function needs to be set higher than the priorities of other vehicle driving assistance functions when only the braking index F is high, the paddle shift operation count C, which is a condition for increasing the priority of smart regenerative braking, may be applied as an addition (+) parameter to the formula for calculating the braking index F (Mathematical expression 4).

According to an embodiment, the controller 150 may use a driving pattern score G, which is the sum of the accelerator pedal score A and the brake pedal score B, to determine a priority for a vehicle driving assistance function.

Accordingly, the controller 150 may determine a priority for a vehicle driving assistance function based on the driving pattern score G, the paddle shift operation count C, and the neutral driving count D.

The controller 150 may determine the priority of the inertial driving function to be higher than the priorities of other vehicle driving assistance functions if the driving pattern score G is less than a preset first comparison value m (G<m).

However, even if the driving pattern score G is less than the first comparison value m (G<m), the controller 150 may determine the priority of the smart regenerative braking function to be higher than the priorities of other vehicle driving assistance functions if the paddle shift operation count C is greater than a first limit value o (C>o).

In other words, the controller 150 may determine the priority of the inertial driving function to be higher than the priorities of other vehicle driving assistance functions if the driving pattern score G is less than the first comparison value m (G<m), and determine the priority of the smart regenerative braking function to be higher than the priorities of other vehicle driving assistance functions if the paddle shift operation count C is greater than the first limit value o (C>o).

The paddle shift operation count C is related to the frequency of execution of the smart regenerative braking function, and a large paddle shift operation count C means that the smart regenerative braking function is executed frequently.

In this manner, the paddle shift operation count C may be applied to determine a priority of a vehicle driving assistance function in order to reflect a driving pattern of a user who frequently executes the smart regenerative braking function.

The controller 150 may determine the priority of the smart regenerative braking function to be higher than the priorities of other vehicle driving assistance functions if the driving pattern score G is equal to or greater than the first comparison value m and less than a preset second comparison value n (m≤G<n).

However, even if the driving pattern score G is equal to or greater than the first comparison value m and less than the second comparison value n (m≤G<n), the controller 150 may determine the priority of the inertial driving function to be higher than the priorities of other vehicle driving assistance functions if the neutral driving count D is greater than a preset second limit value p (D>p).

In other words, the controller 150 may determine the priority of the smart regenerative braking function to be higher than the priorities of other vehicle driving assistance functions if the driving pattern score G is equal to or greater than the first comparison value m and less than the second comparison value n (m≤G<n), and determine the priority of the inertial driving function to be higher than the priorities of other vehicle driving assistance functions if the neutral driving count D is greater than the preset second limit value p (D>p).

The neutral driving count D is related to the frequency of execution of the inertial driving function, and a large neutral driving count D means that the inertial driving function is executed frequently.

In this manner, the neutral driving count D may be applied to determine a priority of a vehicle driving assistance function in order to reflect a driving pattern of a user who frequently executes the inertial driving function.

If the driving pattern score G is equal to or greater than the second comparison value n (G≥n), the controller 150 may determine the priority of the smart cruise control function to be higher than the priorities of other vehicle driving assistance functions.

However, even if the driving pattern score G is equal to or greater than the second comparison value n (G≥n), the controller 150 may determine the priority of the smart regenerative braking function to be higher than the priorities of other vehicle driving assistance functions if the paddle shift operation count C is greater than the first limit value o (C>o).

In other words, the controller 150 may determine the priority of the smart cruise control function to be higher than the priorities of other vehicle driving assistance functions if the driving pattern score G is equal to or greater than the second comparison value n (G≥n), and may determine the priority of the smart regenerative braking function to be higher than the priorities of other vehicle driving assistance functions if the paddle shift operation count C is greater than 0 C>0.

In an embodiment, the first and second comparison values m and n may be set through experiments with various conditions in order to be used to determine which vehicle driving assistance function is useful depending on the driving pattern.

In an embodiment, the first limit value o may be set through experiments with various conditions to be used to determine whether the priority of the smart regenerative braking function is to be determined higher than the priorities of other vehicle driving assistance functions.

In an embodiment, the second limit value p may be set through experiments with various conditions to be used to determine whether the priority of the inertial driving function is to be determined higher than the priorities of other vehicle driving assistance functions.

According to an embodiment, the controller 150 may perform a vehicle driving assistance function according to a preset vehicle driving assistance function execution strategy after determining the priorities of vehicle driving assistance functions.

According to an embodiment, the controller 150 may perform a vehicle driving assistance function based on the priorities of the vehicle driving assistance functions from the next deceleration event after determining the priorities of the vehicle driving assistance functions.

According to an embodiment, the controller 150 may continuously update the priorities of the vehicle driving assistance functions whenever a deceleration event occurs, and may perform a vehicle driving assistance function based on the priorities of the vehicle driving assistance functions from the next deceleration event when the number of updates reaches a preset update threshold value.

According to an embodiment, the controller 150 may perform a vehicle driving assistance function based on initially preset priorities or priorities determined in the previous cycle until the number of updates for the priorities reaches the update threshold value.

The controller 150 may control the actuator 400 according to a vehicle driving assistance function being performed. As the actuator 400 is controlled by the controller 150 in this way, the vehicle 1 can travel based on inertial driving, smart regenerative braking, or smart cruise control.

According to an embodiment, the controller 150 may provide vehicle driving assistance function execution operation information to the output interface 300. Accordingly, the output interface 300 may output vehicle driving assistance function execution operation information. For example, the vehicle driving assistance function operation information may include priority information regarding vehicle driving assistance functions, and the information included in the vehicle driving assistance function operation information is not limited thereto.

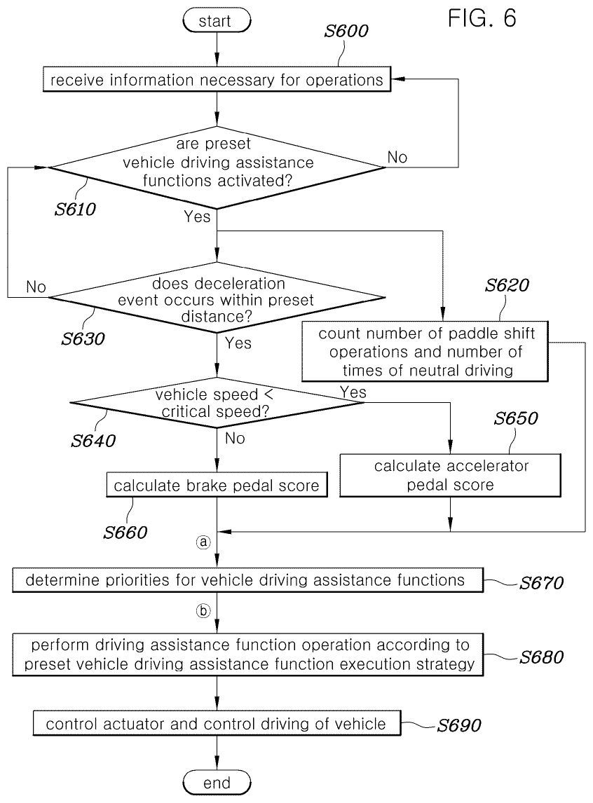

FIG. 6 is a diagram illustrating an operating method of a vehicle driving assistance apparatus according to an embodiment of the present disclosure.

The step-by-step operation illustrated in FIG. 6 may be performed by the vehicle driving assistance apparatus 100 described with reference to FIG. 1 to FIG. 5.

Referring to FIG. 1 to FIG. 6, the vehicle driving assistance apparatus 100 may receive operation information provided from the information acquisition device 200 (step S600).

The operation information may include user input information provided from the first information acquisition device 210, driving environment information provided from the second information acquisition device 220, and vehicle status information provided from the third information acquisition device 230.

Thereafter, the vehicle driving assistance apparatus 100 may determine whether preset vehicle driving assistance functions are activated based on the operation information (step S610).

According to an embodiment, the vehicle driving assistance apparatus 100 may determine whether the vehicle driving assistance functions are activated based on the user input information provided from the first information acquisition device 210. According to an embodiment, the vehicle driving assistance apparatus 100 may determine whether the vehicle driving assistance functions are activated based on the user instruction information provided from the user input interface 211 of the first information acquisition device 210.

The vehicle driving assistance functions to be determined to be activated may include the Smart Cruise Control (SCC) function, the Smart Regenerative Braking System (SRS) function, and the inertial driving function.

In step S610, the vehicle driving assistance apparatus 100 can determine whether the Smart Cruise Control (SCC) function, the Smart Regenerative Braking System (SRS) function, and inertial the driving function are all activated.

Upon determining that the preset vehicle driving assistance functions are not activated (step S610-No), the vehicle driving assistance apparatus 100 may receive operation information (step S600).

Upon determining that the preset vehicle driving assistance functions are activated (step S610-Yes), the vehicle driving assistance apparatus 100 may count the number of paddle shift operations and the number of times of neutral driving based on the operation information (step S620).

According to an embodiment, the vehicle driving assistance apparatus 100 may count the number of paddle shift operations based on an operation signal provided from the paddle shift 212 of the first information acquisition device 210.

According to an embodiment, the vehicle driving assistance apparatus 100 may count the number of times of neutral driving based on a neutral gear signal provided from the gear sensor 233 of the third information acquisition device 230.

Upon determining that the preset vehicle driving assistance functions are activated (step S610-Yes), the vehicle driving assistance apparatus 100 may determine whether a deceleration event occurs within a preset distance based on the operation information (step S630).

According to an embodiment, the vehicle driving assistance 100 whether a apparatus may determine deceleration event occurs based on the driving environment information provided from the second information acquisition device 220.

For example, the vehicle driving assistance apparatus 100 may determine whether there is a preset obstacle or obstacle section in a driving section of the vehicle 1 within the preset distance.

For example, the vehicle driving assistance apparatus 100 may determine whether a deceleration event occurs based on presence or absence of a preceding vehicle, presence of absence of a toll gate, presence of absence of a speed bump, presence or absence of a speed camera, presence or absence of an intersection, and the like, within the preset distance.

Upon determining that no deceleration event occurs within the preset distance (step S630-No), the vehicle driving assistance apparatus 100 may determine whether the preset vehicle driving assistance functions are activated based on the operation information (step S610).

Upon determining that a deceleration event occurs within the preset distance (step S630-Yes), the vehicle driving assistance apparatus 100 may determine whether the vehicle speed is less than a preset critical speed based on the operation information (step S640).

For example, the vehicle driving assistance apparatus 100 may determine whether the vehicle speed is less than the critical speed based on speed information provided from the speed sensor 234 of the third information acquisition device 230.

If the vehicle speed is less than the critical speed (step S640-Yes), the vehicle driving assistance apparatus 100 may calculate an accelerator pedal score based on the operation information (step S650).

In step S650, the vehicle driving assistance apparatus 100 may calculate the accelerator pedal score based on driving environment information provided from the second information acquisition device 220 and accelerator pedal operation information provided from the accelerator pedal position sensor 231 of the third information acquisition device 230.

For example, the vehicle driving assistance apparatus 100 may calculate the accelerator pedal score based on at least two pieces of information among an accelerator pedal operation count, an accelerator pedal stroke, an accelerator pedal operation time, and the remaining distance from the current position of the vehicle 1 to the point where the deceleration event occurs.

If the vehicle speed is equal to or greater than the critical speed (step S640-No), the vehicle driving assistance apparatus 100 may calculate a brake pedal score based on the operation information (step S660).

In step S660, the vehicle driving assistance apparatus 100 may calculate the brake pedal score based on the driving environment information provided from the second information acquisition device 220 and the brake pedal operation information provided from the brake pedal position sensor 232 of the third information acquisition device 230.

For example, the vehicle driving assistance apparatus 100 may calculate the brake pedal score based on at least two pieces of information among a brake pedal operation count, a brake pedal strokes, a brake pedal operation time, and the remaining distance from the current position of the vehicle to the point where the deceleration event occurs.

Thereafter, the vehicle driving assistance apparatus 100 may determine priorities for the vehicle driving assistance functions based on user's driving pattern (step S670).

In step S670, the vehicle driving assistance apparatus 100 may determine the priorities for the vehicle driving assistance functions based on the accelerator pedal score, the brake pedal score, the paddle shift operation count, and the neutral driving count.

Thereafter, the vehicle driving assistance apparatus 100 may perform a vehicle driving assistance function according to a preset vehicle driving assistance function execution strategy (step S680).

In step S680, the vehicle driving assistance apparatus 100 may perform a vehicle driving assistance function based on the priorities of the vehicle driving assistance functions from the next deceleration event.

In step S680, the vehicle driving assistance apparatus 100 may continuously update the priorities for the vehicle driving assistance functions whenever a deceleration event occurs, and when the number of updates reaches a preset update threshold value, may perform a vehicle driving assistance function based on the priorities of the vehicle driving assistance functions from the next deceleration event.

The vehicle driving assistance apparatus 100 may perform a vehicle driving assistance function based on initially preset priorities or priorities determined in the previous cycle until the number of updates for the priorities reaches the update threshold value.

Thereafter, the vehicle driving assistance apparatus 100 may control driving of the vehicle 1 by controlling the actuator 400 according to the vehicle driving assistance function being executed (step S690).

In step S690, the vehicle driving assistance apparatus 100 may control the vehicle 1 to travel based on inertial driving, smart regenerative braking, or smart cruise control.

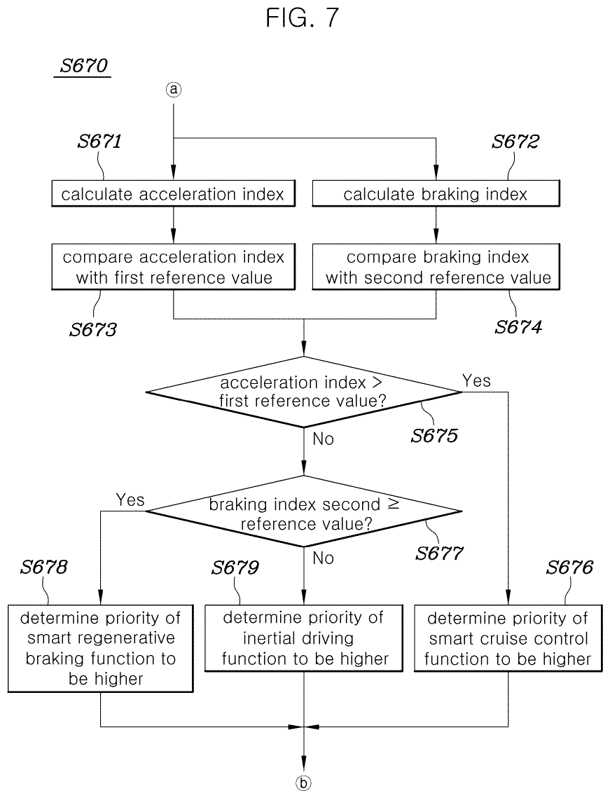

FIG. 7 is a diagram showing a specific example of the priority determination step (step S670) of FIG. 6.

Referring to FIG. 7, the vehicle driving assistance apparatus 100 may determine priorities for vehicle driving assistance functions based on an accelerator pedal score, a brake pedal score, a paddle shift operation count, and a neutral driving count.

Specifically, the vehicle driving assistance apparatus 100 may calculate an acceleration index E based on an accelerator pedal score A and a neutral driving count D (step S671), and calculate a braking index F based on a brake pedal score B, a paddle shift operation count C, and the neutral driving count D (step S672).

In step S671, the vehicle driving assistance apparatus 100 may calculate the acceleration index E according to Mathematical expression 3.

In step S672, the vehicle driving assistance apparatus 100 may calculate the braking index F according to Mathematical expression 4. Thereafter, the vehicle driving assistance apparatus 100 may compare the acceleration index E with the preset first reference value l (step S673) and compare the braking index F with the preset second reference value k (step S674).

Thereafter, the vehicle driving assistance apparatus 100 may determine whether the acceleration index E is equal to or greater than the first reference value l (step S675).

If the acceleration index E is equal to or greater than the first reference value l (step S675-Yes), the vehicle driving assistance apparatus 100 may determine the priority of the smart cruise control (SCC) function to be higher than priorities of other vehicle driving assistance functions (step S676).

If the acceleration index E is less than the first reference value l (step S675-No), the vehicle driving assistance apparatus 100 may determine whether the braking index F is equal to or greater than the second reference value k (step S677).

If the braking index F is equal to or greater than the second reference value k (step S677-Yes), the vehicle driving assistance apparatus 100 may determine the priority of the smart regenerative braking (SRS) function to be higher than priorities of other vehicle driving assistance functions (step S678).

If the braking index F is less than the second reference value k (step S677-No), the vehicle driving assistance apparatus 100 may determine the priority of the inertial driving function to be higher than priorities of other vehicle driving assistance functions (step S679).

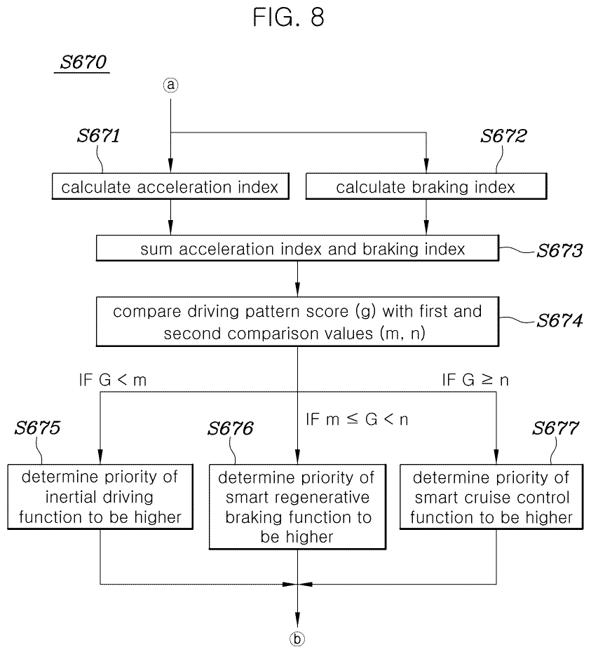

FIG. 8 is a diagram showing another specific example of the priority determination step (step S670) of FIG. 6.

Referring to FIG. 8, the vehicle driving assistance apparatus 100 may determine priorities for vehicle driving assistance functions based on an accelerator pedal score, a brake pedal score, a paddle shift operation count, and a neutral driving count.

Specifically, the vehicle driving assistance apparatus 100 may calculate an acceleration index E based on an accelerator pedal score A and a neutral driving count D (step S671), and calculate a braking index F based on a brake pedal score B, a paddle shift operation count C, and the neutral driving count D (step S672).

In step S671, the vehicle driving assistance apparatus 100 may calculate the acceleration index E according to Mathematical expression 3.

In step S672, the vehicle driving assistance apparatus 100 may calculate the braking index F according to Mathematical expression 4.

Thereafter, the vehicle driving assistance apparatus 100 may sum the acceleration index E and the braking index F (step S673).

Thereafter, the vehicle driving assistance apparatus 100 may compare a driving pattern score G generated by summing the acceleration index E and the braking index F with the first and second comparison values m and n (step S674).

If the driving pattern score G is less than the first comparison value m (G<m), the vehicle driving assistance apparatus 100 may determine the priority of the inertial driving function to be higher than priorities of other vehicle driving assistance functions (step S675).

According to an embodiment, the vehicle driving assistance apparatus 100 may further compare the paddle shift operation count C with the preset first limit value o in step S675.

As a result of comparing the paddle shift operation count C with the first limit value o, if the paddle shift operation count C is greater than the first limit value o (C>o), the vehicle driving assistance apparatus 100 may determine the priority of the smart regenerative braking function to be higher than priorities of other vehicle driving assistance functions. In addition, if the paddle shift operation count C is equal to or less than the first limit value o (C≤o), the vehicle driving assistance apparatus 100 may determine the priority of the inertial driving function to be higher than priorities of other vehicle driving assistance functions.

If the driving pattern score G is equal to or greater than the first comparison value m and less than the second comparison value n (m≤G<n), the vehicle driving assistance apparatus 100 may determine the priority of the smart regenerative braking (SRS) function to be higher than the priorities of other vehicle driving assistance functions (step S676).

According to an embodiment, the vehicle driving assistance apparatus 100 may further compare the neutral driving count D with the preset second limit value p in step S676.

As a result of comparing the neutral driving count D with the second limit value p, if the neutral driving count D is greater than the second limit value p (D>p), the vehicle driving assistance apparatus 100 may determine the priority of the inertial driving function to be higher than the priorities of other vehicle driving assistance functions. If the neutral driving count D is equal to or less than the second limit value p (D≤p), the vehicle driving assistance apparatus 100 may determine the priority of the smart regenerative braking (SRS) function to be higher than the priorities of other vehicle driving assistance functions.

If the driving pattern score G is equal to or greater than the second comparison value n (G≥n), the vehicle driving assistance apparatus 100 may determine the priority of the smart cruise control (SCC) function to be higher than the priorities of other vehicle driving assistance functions (step S677).

According to an embodiment, the vehicle driving assistance apparatus 100 may further compare the paddle shift operation count C with the first limit value o in step S677. As a result of comparing the paddle shift operation count C with the first limit value o, if the paddle shift operation count C is greater than the first limit value o (C>o), the vehicle driving assistance apparatus 100 may determine the priority of the smart regenerative braking function to be higher than the priorities of other vehicle driving assistance functions. In addition, if the paddle shift operation count C is equal to or less than the first limit value o (C≤o), the vehicle driving assistance apparatus 100 may determine the priority of the inertial driving function to be higher than the priorities of other vehicle driving assistance functions.

According to embodiments of the present disclosure, it is possible to provide a vehicle driving assistance apparatus implemented to perform vehicle driving assistance functions in consideration of driver's driving tendencies, an operating method thereof, and a vehicle including the same.

According to an embodiments of the present disclosure, it is possible to provide a vehicle driving assistance apparatus implemented to determine priorities for vehicle driving assistance functions that cannot be performed simultaneously among vehicle driving assistance functions and to perform vehicle driving assistance functions according to the determined priorities, an operating method thereof, and a vehicle including the same.

Since the vehicle driving assistance apparatus according to an embodiments of the present disclosure performs vehicle driving assistance functions in consideration of driver's driving tendencies, the efficiency and usability of the vehicle driving assistance functions can be improved.

In addition, since the vehicle driving assistance apparatus according to embodiments of the present disclosure performs vehicle driving assistance functions in consideration of driver's driving tendencies, effects of reducing unnecessary fuel consumption and improving fuel efficiency can be anticipated.

The effects that can be obtained from the present disclosure are not limited to the effects mentioned above, and other effects that are not mentioned can be clearly understood by those having ordinary skill in the art to which the present disclosure belongs from the description below.

Although embodiments of the present disclosure have been described in more detail with reference to the attached drawings, the present disclosure is not necessarily limited to these embodiments, and various modifications may be made without departing from the technical idea of the present disclosure. Accordingly, the embodiments disclosed in this specification are not intended to limit the technical idea of the present disclosure, but to explain the same, and the scope of the technical idea of the present disclosure is not limited by such embodiments. Therefore, it should be understood that the embodiments described above are examples in all aspects and not restrictive. The scope of the present disclosure should be interpreted by the claims, and all technical ideas within a scope equivalent thereto should be interpreted as being included in the scope of the rights of the present disclosure.

What is claimed is:

1. A vehicle driving assistance apparatus, the apparatus comprising:
a communication device configured to receive operation information required to perform vehicle driving assistance functions; and
a controller configured to:
determine a priority for two or more functions that are not able to be performed simultaneously, based on driving tendencies of a driver, among the vehicle driving assistance functions, wherein the vehicle driving tendencies of the driver are analyzed based on the operation information, and
control driving of a vehicle by controlling an actuator based on the determined priority.

2. The apparatus of claim 1, wherein the vehicle driving assistance functions include a smart cruise control function, a smart regenerative braking function, and an inertial driving function.

3. The apparatus of claim 2, wherein when a preset deceleration even occurs, the controller is further configured to
preferentially perform one of the smart cruise control function, the smart regenerative braking function, or the inertial driving function based on the determined priority.

4. The apparatus of claim 1, wherein the controller is further configured to determine priorities for the vehicle driving assistance functions when all of the vehicle driving assistance functions are activated.

5. The apparatus of claim 1, wherein the controller is further configured to:
count, based on the operation information, a number of paddle shift operations and a number of times of neutral driving,
calculate an accelerator pedal score and a brake pedal score, and
determine priorities for the vehicle driving assistance functions based on the number of paddle shift operations, the number of times of neutral driving operations, the accelerator pedal score, and the brake pedal score.

6. The apparatus of claim 5, wherein the operation information includes an operation signal provided from a paddle shift and a neutral gear signal provided from a gear sensor,
wherein the controller is further configured to:
count the number of paddle shift operations based on the operation signal, and
count the number of times of neutral driving based on the neutral gear signal.

7. The apparatus of claim 5, wherein the controller is further configured to:
determine whether an operation execution condition is satisfied based on the operation information, and
calculate the accelerator pedal score and the brake pedal score in response to the operation execution condition being satisfied.

8. The apparatus of claim 7, wherein the controller is further configured to:
determine whether a deceleration event occurs within a preset distance based on the operation information, and
determine that the operation execution condition is satisfied in response to a determination that the deceleration event occurs within the preset distance.

9. The apparatus of claim 8, wherein the operation information includes information on a remaining distance to an obstacle or an obstacle section present in a driving section of the vehicle, and
wherein the controller is further configured to determine that the deceleration event occurs in response to the obstacle or the obstacle section being present within the preset distance.

10. The apparatus of claim 7, wherein the operation information includes vehicle speed information provided by a speed sensor, and
wherein the controller is further configured to:
compare, in response to the operation execution condition being satisfied, the vehicle speed information with a preset critical speed, and
calculate an accelerator pedal score or a brake pedal score based on a comparison result.

11. The apparatus of claim 10, wherein the controller is further configured to:
calculate the accelerator pedal score in response to a vehicle speed being less than the preset critical speed, and
calculate the brake pedal score in response to the vehicle speed being equal to or greater than the preset critical speed.

12. The apparatus of claim 5, wherein the operation information includes accelerator pedal operation information provided from an accelerator pedal position sensor, brake pedal operation information provided from a brake pedal position sensor, and information on a remaining distance to an obstacle or obstacle section present in a driving section of the vehicle,
wherein the controller is further configured to:
calculate the accelerator pedal score based on the accelerator pedal operation information and the information on the remaining distance, and
calculate the brake pedal score based on the brake pedal operation information and the information on remaining distance.

13. The apparatus of claim 5, wherein the controller is further configured to:
calculate an acceleration index based on the accelerator pedal score and the number of times of neutral driving,
calculate a braking index based on the brake pedal score, the number of times of neutral driving, and the number of paddle shift operations, and
determine the priorities for the vehicle driving assistance functions based on the acceleration index and the braking index.

14. The apparatus of claim 13, wherein the controller is further configured to:
compare the acceleration index with a preset first reference value, and
determine a smart cruise controller function to be preferentially performed in response to the acceleration index being equal to or greater than the preset first reference value.

15. The apparatus of claim 13, wherein the controller is further configured to:
compare the acceleration index with a preset first reference value,
compare the braking index with a preset second reference value in response to the acceleration index being less than the preset first reference value,
determine a smart regenerative braking function to be performed preferentially in response to the braking index being equal to or greater than the preset second reference value, and
determine an inertial driving function to be performed preferentially in response to the braking index being less than the preset second reference value.

16. The apparatus of claim 5, wherein the controller is further configured to determine the priorities for the vehicle driving assistance functions based on a driving pattern score corresponding to a sum of the accelerator pedal score and the braking pedal score.

17. The apparatus of claim 16, wherein the controller is further configured to:
compare the driving pattern score with a first comparison value and a second comparison value set in advance,
determine inertial driving to be performed preferentially in response to the driving pattern score being less than the first comparison value,
determine a smart regenerative braking function to be performed preferentially in response to the driving pattern score being equal to or greater than the first comparison value and less than the second comparison value, and
determine a smart cruise control function to be performed preferentially in response to the driving pattern score being equal to or greater than the second comparison value.

18. The apparatus of claim 17, wherein the controller is further configured to:
compare the number of paddle shift operations or the number of times of neutral driving with a preset limit value based on a vehicle driving assistance function determined based on the driving pattern score, and
change a vehicle driving assistance function to be performed preferentially based on a comparison result.

19. An operating method of a vehicle driving assistance apparatus, the method comprising:
receiving operation information required to perform vehicle driving assistance functions;
determining a priority for two or more functions that are not able to be performed simultaneously based on driving tendencies of a driver, among the vehicle driving assistance functions, wherein the vehicle driving tendencies of the driver are analyzed based on the operation information; and
controlling driving of a vehicle by controlling an actuator based on the determined priority,
wherein the vehicle driving assistance functions include the two or more functions that are not able to be performed simultaneously.

20. A vehicle comprising:
a vehicle driving assistance apparatus configured to
determine a priority for two or more functions that are not able to be performed simultaneously based on driving tendencies of a driver, among vehicle driving assistance functions, wherein the driving tendencies of the driver are analyzed based on received operation information, and
control driving of the vehicle by controlling an actuator based on the determined priority; and
an information acquisition device configured to
acquire the operation information, and
provide the operation information to the vehicle driving assistance apparatus.
